(19) United States
(12) Patent Application Publication
(10) Pub. No.: US 2011/0274909 A1
(43) Pub. Date: Nov. 10, 2011

(54) PU PRODUCT AND A METHOD FOR MAKING THE SAME

(76) Inventors: Chi-Wen LEE, Taipei (TW); Tien-Chai KUO, Taipei (TW)

(21) Appl. No.: 12/774,150

(22) Filed: May 5, 2010

(51) Int. Cl. B32B 5/20; B29C 44/24

(52) U.S. Cl. 428/304.4; 264/45.3

(57) ABSTRACT

A PU product and a method for making the same prepare a stereoscopic mold in accordance with a formation of the PU product. Accordingly, a layer of particular material is sprayed in cavities of the stereoscopic mold via a spraying device. Additionally, a PU foaming material is poured into the cavities of the stereoscopic mold via a pouring device. Finally, the PU foaming material is wrapped in the particular material as an outer case via a mold forming technique to form the PU product. Correspondingly, the risk of manufacturing bad products could be decreased, and the hardness of the PU product surface could be increased, so that the applicable scope of the product could be enlarged.

### BACKGROUND OF THE INVENTION

1. Field of the Invention

The present invention relates to a PU product and a method for making the same, in particular to an advanced method for making the PU product with a high quality.

2. Description of the Related Art

PVC, a contracted form for Polyvinylchloride, is called “poison plastic” by the Greenpeace. In fact, PVC is a kind of chloride plastic. Further, since the PVC is a chloride, its softness is variable by adding different amount of plasticizer. Wherein, the PVC contained no plasticizer is as rigid as a water pipe; whereas, the PVC contained with plasticizer could be as yielding as a cling film. As a result, the general PVC could be separated into the soft PVC and the rigid PVC according to the softness of the PVC. Moreover, in view of the wide flexibility of the PVC, producers could conveniently manufacture various PVC products with divergent softness. Preferably, such PVC properties in fact bring the PVC producers a lower manufacturing technique and cost as well.

Besides the plasticizer, the PVC has a poor thermal stability. Therefore, in order to prevent the PVC products from cracks under the sun or high temperature, a stabilizer has to be added into the product. Herein, the stabilizer usually adopts lead, cadmium, and zinc, or the like heavy metal. Obviously, the PVC product is not only made of PVC; there are also noxious plasticizer and stabilizer contained therein harmful to our health and environment. Adversely, the PVC product contained neither plasticizer nor stabilizer is in fact a useless product to our life.

Thus, the PVC called as the “poison plastic” by the Greenpeace neither merely refers to the PVC without filler, nor solely refers to the PVC contained any filler. Herein, the “poison” part of the PVC product is directed to the entire life cycle thereof, including mining the raw materials, manufacturing the product, and discarding the product. Evidently, all the abovementioned phases facilely damage our environment and health.

In order to settle the problems generated in time of manufacturing the PVC product, PU (polyurethane) material is gradually given weight to an expansive utilization. Herein, the PU foaming material is widely applied to manufacturing a variety of products. For example, as shown in FIGS. 2A and 2B, a mold for making a PU pad is referred. In manufacturing, users only need to pour the PU foaming material into cavities of the mold via a pouring device (as shown in FIG. 3), and a PU pad is accordingly formed. However, such PU pad has the following shortcomings:
1. The aforesaid forming method readily permits bubble pores to be formed at the surface periphery of the PU pad. Herein, the bubble pores have to be artificially cleared and mended; however, the manual elimination of the bubble pores easily results in an imperfect finished product; thus, it is difficult to promote the productivity of the PU pad.
2. In view of the softness possessed in the PU foaming material, the correspondent product usually includes a softer appearance. As a result, in time of making products in accordance with the designed mold, the application of such material is limited.

Moreover, the plastic, the iron, and the wood materials are mostly adopted in the existing building materials of doors. Such materials are accessible, and they could be readily processed. However, adopting aforementioned materials in fact easily results in the following shortcomings:
1. The plastic doors: They are characterized by a poor soundproof effect. Additionally, the plastic material is light and readily contributes to an inferior quality, so it is difficult to satisfy users' safety needs. Moreover, the environmental protection is hard to achieve in view of the adverse plastic material.
2. The iron doors: The iron material brings about a rather heavier door plate. However, if the iron door is placed in a humid environment, the door facilely becomes rusty; therefore, the maintenance of such iron door is difficult.
3. The wooden door: Although possessing a higher quality, the wooden door is unbenefited to the essential environment because of the daily reducing natural wood. Moreover, if the wood is placed in the humid climate, the wood likely becomes rotten. Even worse, some wood adversely breeds termites, ants, and other insect pests.

As a result, in order to settle the shortcomings brought by adopting aforementioned materials, the pouring means is also applied to reinforce the strength of the building material. Nevertheless, the same disadvantages still exist in time of pouring and processing the PU material.

Therefore, the conventional techniques need to be mended.

Accordingly, the applicant of the present invention offers an improving technique, a PU product and a method for making the same, to resolve the problems included in the existing practice.

### SUMMARY OF THE INVENTION

It is an object of the present invention to form an outer case on a PU foaming material in time of manufacture so as to avoid bubble pores and improve the external appearance of the product, so that the manufacture is less laborious and the related cost could be favorably lowered.

A further object of the present invention is to lower the risk of manufacturing a defective product; moreover, by effectively increasing the surface hardness of the PU product, the application scope of the PU product could be encouraged.

Another further object of the present invention is to provide a PU product and a method for making the same. By means of applying afore product and method to doors, the doors preferably achieves a moisture-proof effect, an elaborate appearance, and a graceful performance. Favorably, the using life of such product is rather long, so that less wood will be wasted, thereby preserving a real green environment as well as encouraging a beneficial ecology.

The PU product and the method for making the same in conformity with the present invention substantially prepare a stereoscopic mold in accordance with a formation of a PU product. Accordingly, a layer of particular material is sprayed in cavities of the stereoscopic mold via a spraying device. Additionally, a PU foaming material is poured into the cavities of the stereoscopic mold via a pouring device. Finally, the particular material as an outer case is used to wrap the PU foaming material via a mold forming technique to form the PU product.

### BRIEF DESCRIPTION OF THE DRAWINGS

FIG. 1 is a flowchart showing a method for making a PU product of the present invention;

FIG. 2A is a schematic view showing the stereoscopic mold in opening;

FIG. 2B is a schematic view showing the stereoscopic mold in closing;

FIG. 3 is a schematic view showing a pouring device;

FIG. 4 is a schematic view showing a spraying device;

FIG. 5 is a schematic view showing a bedframe;

FIG. 6 is another schematic view showing a method for making a PU product of the present invention;

FIG. 7 is another schematic view showing the stereoscopic mold in opening; and

FIG. 8 is a schematic view showing a door plate.

### DETAILED DESCRIPTION OF THE PREFERRED EMBODIMENTS

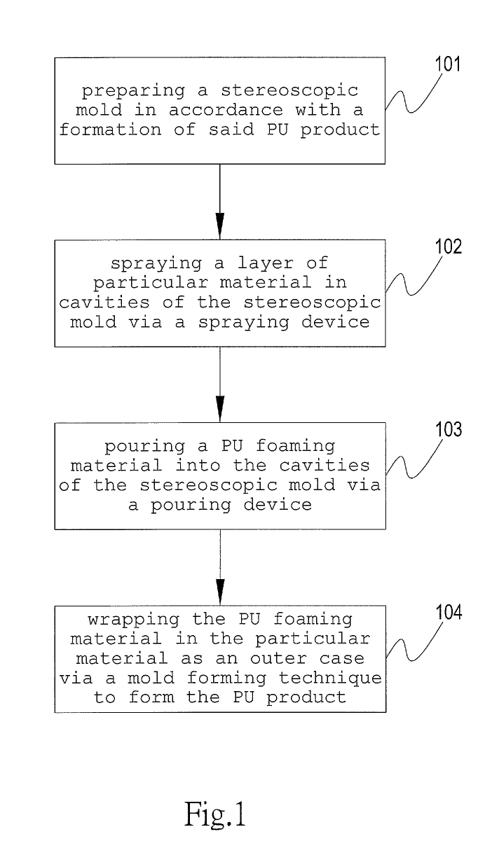

FIG. 1 shows a flowchart of a method for making a PU product of the present invention. The method comprises steps of:

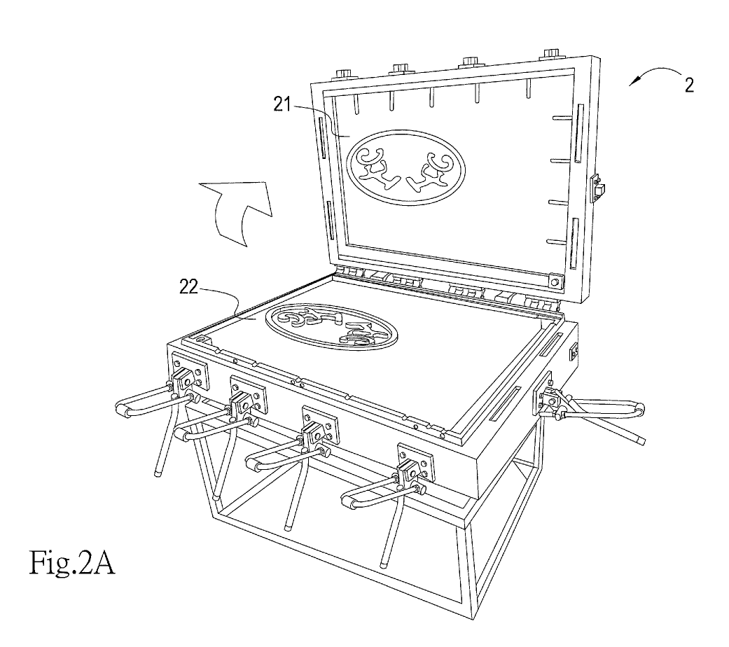

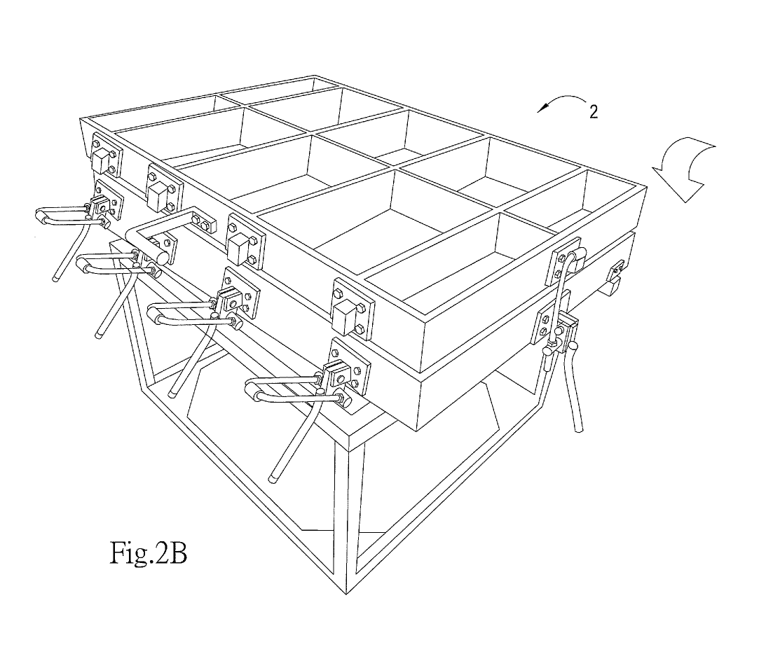

(A) Preparing a stereoscopic mold in accordance with a formation of a PU product 101;

Wherein, the stereoscopic mold 2 as shown in FIGS. 2A and 2B includes cavities 21, 22. The cavities 21, 22 are applied to accommodate a PU foaming material;

(B) Spraying a layer of particular material in the cavities of the stereoscopic mold via a spraying device 102;

Wherein, the particular material adopts a compound made from polyol and isocyanate, and a proportion of the polyol to the isocyanate is about 1:1;

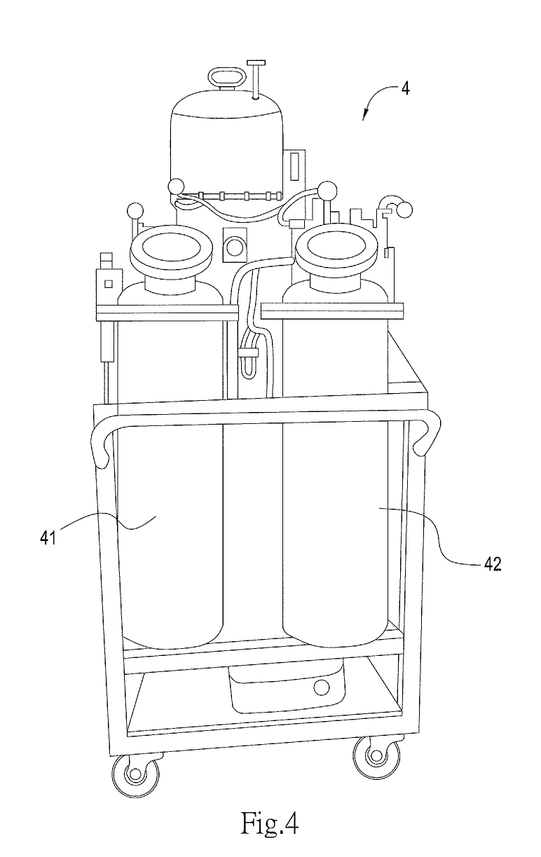

The spraying device 4 shown in FIG. 4 includes two tanks: a first storing tank 41 is employed to store a hardening agent (e.g. isocyanate), and a second storing tank 42 is employed to store a main agent (e.g. polyol);

(C) Pouring the PU foaming material into the cavities of the stereoscopic mold via a pouring device 103;

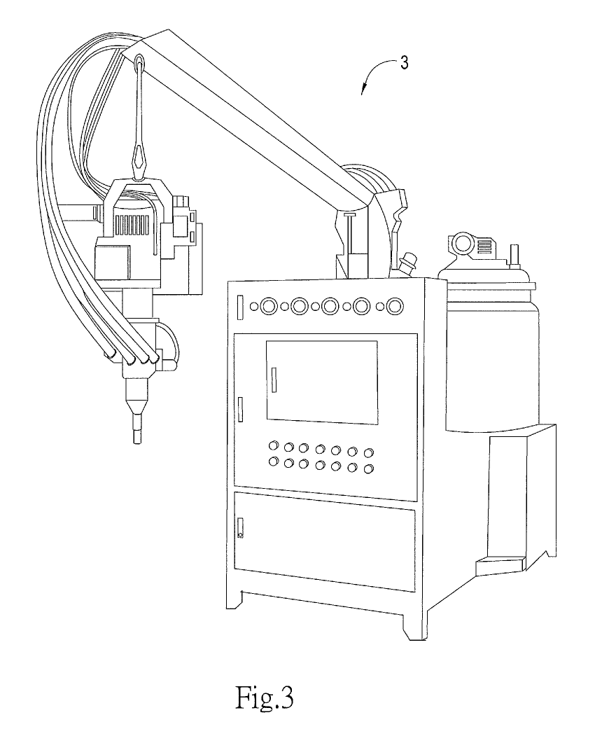

The pouring device 3 shown in FIG. 3 is able to pour the PU foaming material into the stereoscopic mold; and

(D) Wrapping the PU foaming material in the particular material as an outer case via a mold forming technique to form the PU product 104;

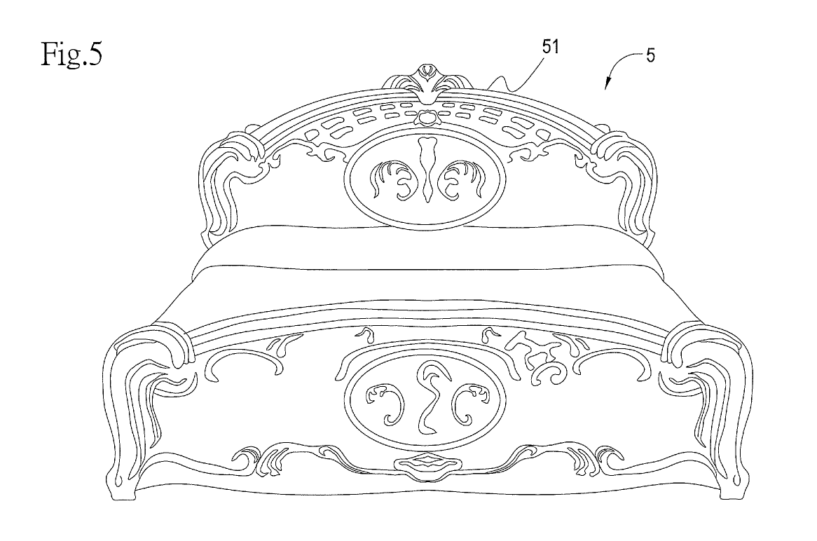

The PU product includes an outer case filled with the PU foaming material. With different stereoscopic molds, various complicated products with hardness could be properly manufactured. A bedframe 5 as shown in FIG. 5 includes a headboard 51, which is conventionally formed by wooden sculpture; in the future, the complicated patterns on the headboard 51 could be readily formed by the present invention.

Herein, the step (B) is suited to the stereoscopic mold which involves a large dimension. If a smaller dimension of the stereoscopic mold is operated, a trace of a particular material could be alternatively poured via high pressure. Thence, the particular material is spread via air pressure and wind power on the cavities, or the coat of the particular material is evenly spread on the cavities via proper tools. As a result, the same favorable result could be still achieved.

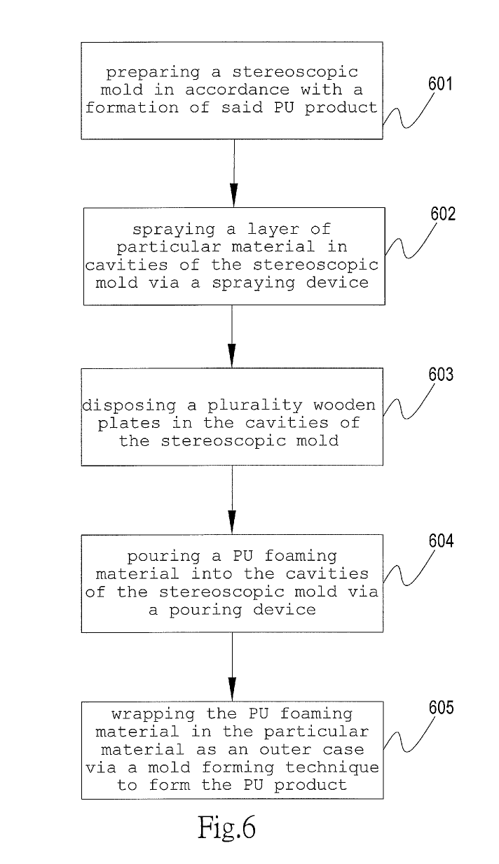

Further referring to FIG. 6, the present invention is applied to manufacture doors as follows:

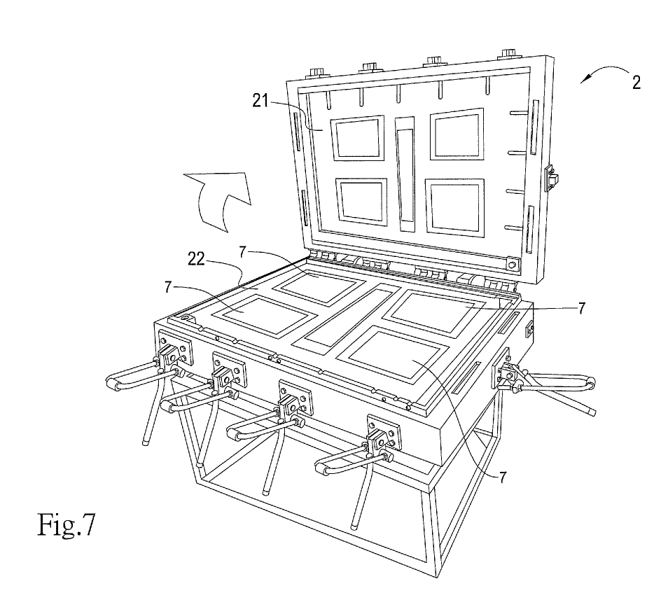

(A) Preparing a stereoscopic mold in accordance with a formation of a PU product 601; wherein, the stereoscopic mold 2 as shown in FIGS. 7 and 2B includes cavities 21, 22 for accommodating the PU foaming material;

(B) Spraying a layer of a specific material in the cavities of the stereoscopic mold by a spraying device 603. Wherein, the particular material adopts a compound made from polyol and isocyanate, and a proportion of the polyol to the isocyanate is about 1:1. Moreover, the spraying device 4 shown in FIG. 4 includes two tanks: a first storing tank 41 is employed to store a hardening agent (e.g. isocyanate), and a second storing tank 42 is employed to store a main agent (e.g. polyol);

(C) Disposing a plurality of wooden plates in the cavities of the stereoscopic mold 602. For instance, the wooden plates 7 are placed in the cavity 22 as shown in FIG. 7;

(D) Pouring the PU foaming material into the cavities of the stereoscopic mold via a pouring device 604; The pouring device 3 shown in FIG. 3 is able to pour the PU foaming material into the stereoscopic mold; and

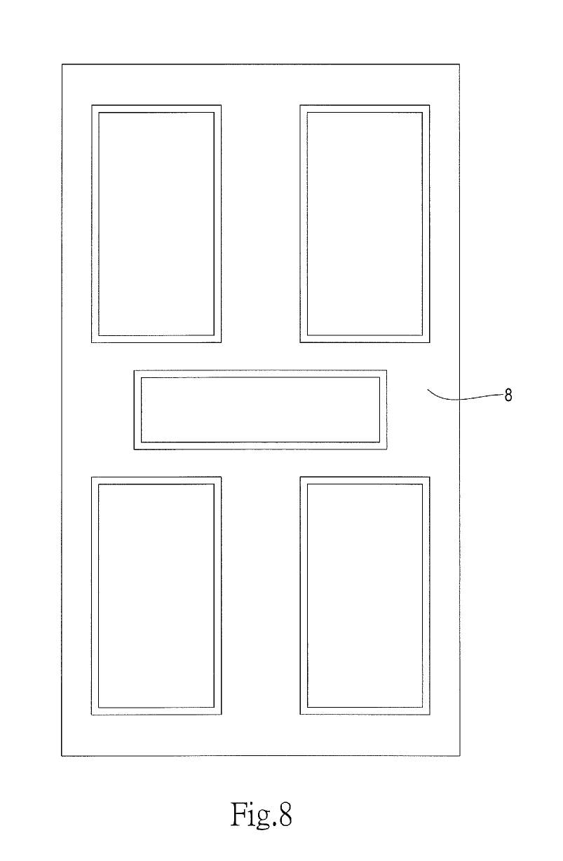

(E) Wrapping the PU foaming material and the wooden plate in the particular material as an outer case via a mold forming technique to form the PU product 605; the PU product includes an outer case filled with the PU foaming material. With different stereoscopic molds, various complicated door plates with hardness could be properly manufactured. A door plate 8 as shown in FIG. 8 includes a wooden plate 7 for being served as the basic frame to support the PU foaming material poured in the cavities, thence resulting in the finalization by means of the wooden plate 7 being wrapped in the PU foaming material.

Comparatively, the present invention has the following advantages:
1. The present invention utilizes an outer case to be formed on the surface of the PU foaming material during the manufacturing procedure; whereby, the appearance of the PU product could be more flawless.
2. The present invention promotes the hardness of the external of the PU product; whereby, the application scope of the PU product could be increased.
3. The application of the present invention to the manufacturing of the door plate preferably settles the existing shortcomings of the conventional door plate, i.e. the poor moisture-proof effect, the unavoidable rusty characteristic, and the inferior quality. Herein, by the cooperation of the PU foaming material and the wooden plate, the accordingly manufactured door plate achieves the advantages like a superior quality, and a concise as well as a speedy manufacturing process. Even better, the amount of wooden material could be lessened to preserve a green environment.

The available embodiment of the present invention as depicted above does not limit the scope of the present invention.

Above description has shown the objects and substantial embodiments of the present invention, which indicate the present invention should be granted allowable, thereby the application being filed.

What is claimed is:

1. A method for making a PU product comprising steps of:
(A) preparing a stereoscopic mold in accordance with a formation of said PU product;
(B) spraying a layer of particular material in cavities of said stereoscopic mold via a spraying device;
(C) pouring a PU foaming material into said cavities of said stereoscopic mold via a pouring device; and
(D) wrapping said PU foaming material in said particular material as an outer case via a mold forming technique to form said PU product.

2. The method as claimed in claim 1, wherein, said particular material adopts a compound from polyol and isocyanate.

3. The method as claimed in claim 2, wherein, a proportion of said polyol to said isocyanate is about 1:1.

4. A method for making a PU product comprising steps of:
(A) preparing a stereoscopic mold in accordance with a formation of said PU product;
(B) pouring a trace of a particular material via high pressure into cavities of said stereoscopic mold, and spreading said particular material on said cavities via air pressure and wind power, or evenly spreading said particular material on said cavities via tools;
(C) pouring a PU foaming material into said cavities of said stereoscopic mold via a pouring device; and
(D) wrapping said PU foaming material in said particular material as an outer case via a mold forming technique to form said PU product.

5. The method as claimed in claim 4, wherein, said particular material adopts a compound from polyol and isocyanate.

6. The method as claimed in claim 5, wherein, a proportion of said polyol to said isocyanate is about 1:1.

7. A method for making a PU product comprising steps of:
(A) Preparing a stereoscopic mold in accordance with a formation of a PU product;
(B) Spraying a layer of a specific material in the cavities of the stereoscopic mold by a spraying device;
(C) Disposing a plurality of wooden plates in the cavities of said stereoscopic mold;
(D) Pouring the PU foaming material into the cavities of the stereoscopic mold via a pouring device; and
(E) Wrapping the PU foaming material and the wooden plate in the particular material as an outer case via a mold forming technique to form the PU product.

8. The method as claimed in claim. 7, wherein, said particular material adopts a compound from polyol and isocyanate.

9. The method as claimed in claim 8, wherein, a proportion of said polyol to said isocyanate is about 1:1.

10. A PU product comprising:
an outer case mixed by polyol and isocyanate for wrapping a PU foaming material; and
a PU foaming material for filling an interior of said outer case.
